(19) United States
(12) Patent Application Publication
(10) Pub. No.: US 2011/0301997 A1
(43) Pub. Date: Dec. 8, 2011

(54) SYSTEM AND METHOD FOR MANAGING FLEET VEHICLES OR EMPLOYEE OWNED VEHICLES

(75) Inventors: Anthony Bruce Gale, Hutto, TX (US); Mary Ann Ferris-Young, Walker, MI (US); Gregory Ronald Coniglio, Alden, NY (US)

(73) Assignee: ECOLOGY & ENVIRONMENT, INC., Lancaster, NY (US)

(21) Appl. No.: 12/794,090

(22) Filed: Jun. 4, 2010

(51) Int. Cl. G06Q 10/00

(52) U.S. Cl. 705/7.26

(57) ABSTRACT

A computer based system for managing vehicles, including: a memory unit for at least one specially programmed computer, for storing a request from a first user regarding a trip including a starting point, destination, and schedule. The system includes a processor for the computer for receiving a request from a second user regarding a trip including a starting point, a destination, and a schedule. The processor calculates whether the requests are compatible by calculating whether the following are true: the starting points are within a range of each other; the destinations are within a range of each other; and the schedules are within a range of each other. If the requests are compatible, the processor is for: assigning a vehicle from a plurality of vehicles to the requests; and displaying a notification regarding the assignment of the vehicle.

### CROSS REFERENCE TO RELATED APPLICATIONS

The following co-pending application is incorporated herein by reference in its entirety: U.S. patent application Ser. No. 12/627,329, entitled, “METHOD AND SYSTEM FOR MANAGING SPECIAL PARATRANSIT TRIPS,” filed Nov. 30, 2009.

### FIELD OF THE INVENTION

The present disclosure relates generally to a system and method to manage fleet vehicles or employee owned vehicles used for business purposes. Specifically, the present disclosure dynamically groups riders and determines environmental benefits of such management.

### BACKGROUND OF THE INVENTION

It is known to manage a fleet of vehicles with respect to inventory, maintenance, tracking, fuel tracking and management, for example, using fuel islands and various types of transmit/receive technologies.

### BRIEF SUMMARY OF THE INVENTION

According to aspects illustrated herein, there is provided a computer based method for managing vehicles, including: storing, in a memory unit for at least one specially programmed computer, a first request from a first user regarding a first trip, the first request including a first starting point, a first destination, and a first schedule for the first trip; receiving, using a processor for the at least one specially programmed computer, a second request from a second user regarding a second trip, the second request including a second starting point, a second destination, and a second schedule for the second trip; and calculating, using the processor, whether the first and second requests are compatible by calculating, using the processor, whether the following are true: the first and second starting points are within a first range of each other; the first and second destinations are within a second range of each other; and the first and second schedules are within a third range of each other. If the first and second requests are compatible, the method: assigns, using the processor, a first vehicle from a plurality of vehicles to the first and second requests; and displays, using the processor, a notification regarding the assignment of the first vehicle.

According to aspects illustrated herein, there is provided a computer based method for managing vehicles, including: storing, in a memory unit for at least one specially programmed computer, a value for a parameter associated with operation of the plurality of vehicles and a value for a baseline occupancy rate; and receiving, using a processor for the at least one specially programmed computer, a plurality of requests from a plurality of users regarding respective trips, each request including a respective distance for a respective trip; forming, using the processor, a plurality of combined requests from the plurality of requests, each combined request including: two or more requests from the plurality of requests; a respective combined distance substantially equal to a respective distance from the two or more requests; and a respective first number of users from the plurality of users, the first number greater than the value for the baseline occupancy rate. The method includes: assigning, using the processor, a respective single vehicle, from the plurality of vehicles, to said each combined request; and multiplying, using the processor: a sum of the respective distances by the value for the baseline occupancy rate to generate a first product; the first product by the value for the parameter to generate a fleet environmental baseline value; and a sum of the respective combined distances by the value for the parameter to generate a fleet environmental value.

According to aspects illustrated herein, there is provided a computer based system for managing vehicles, including: a memory unit for at least one specially programmed computer, for storing a first request from a first user regarding a first trip, the first request including a first starting point, a first destination, and a first schedule for the first trip. The system includes a processor the at least one specially programmed computer for: receiving a second request from a second user regarding a second trip, the second request including a second starting point, a second destination, and a second schedule for the second trip; and calculating whether the first and second requests are compatible by calculating, using the processor, whether the following are true: the first and second starting points are within a first range of each other; the first and second destinations are within a second range of each other; and the first and second schedules are within a third range of each other. If the first and second requests are compatible, the processor is for: assigning a first vehicle from a plurality of vehicles to the first and second requests; and displaying a notification regarding the assignment of the first vehicle.

According to aspects illustrated herein, there is provided a computer based method for managing vehicles, including: a memory unit for at least one specially programmed computer for storing a value for a parameter associated with operation of the plurality of vehicles and a value for a baseline occupancy rate. The system includes a processor for: receiving a plurality of requests from a plurality of users regarding respective trips, each request including a respective distance for a respective trip; and forming a plurality of combined requests from the plurality of requests, each combined request including: two or more requests from the plurality of requests; a respective combined distance substantially equal to a respective distance from the two or more requests; and a respective first number of users from the plurality of users, the first number greater than the value for the baseline occupancy rate. The processor is for: assigning a respective single vehicle, from the plurality of vehicles, to said each combined request; and multiplying: a sum of the respective distances by the value for the baseline occupancy rate to generate a first product; the first product by the value for the parameter to generate a fleet environmental baseline value; and multiplying, using the processor, a sum of the respective combined distances by the value for the parameter to generate a fleet environmental value.

This and other objects, features and advantages of the present invention will become readily apparent to those having ordinary skill in the art from a reading and study of the following detailed description of the invention, in view of the drawing and appended claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a computer based system for managing vehicles; and,

FIGS. 2 through 14 are photographs of screens illustrating operation of a computer based system for managing vehicles.

### DETAILED DESCRIPTION OF THE INVENTION

At the outset, it should be appreciated that like drawing numbers on different drawing views identify identical, or functionally similar, structural elements of the invention. It is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

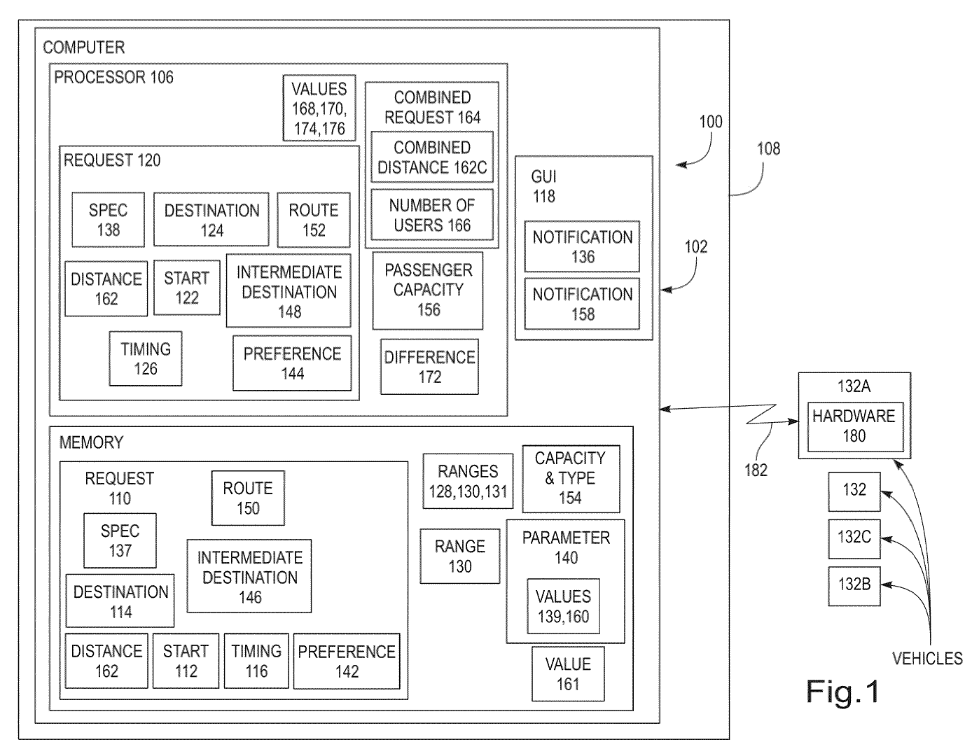

FIG. 1 is a schematic block diagram of computer based system 100 for managing vehicles. The system includes at least one specially-programmed general purpose computer, for example, computer 102, with memory element 104, and processor 106. Computer 102 can be any computer or plurality of computers known in the art. In one embodiment, the computer is located in single location with which system 100 is associated, for example, location 108. In another embodiment (not shown), all or parts of the computer are remote from a location with which system 100 is associated. Processor 106 can be any processor known in the art.

The memory element is for storing request 110 from a first user regarding a first trip. The request includes starting point 112, destination 114, and timing, schedule, or itinerary, 116 for the trip. The processor is for receiving, for example, via graphical user interface (GUI) 118, request 120 from a second user regarding a second trip. Request 120 includes starting point 122, destination 124, and timing 126 for the second trip. GUI 118 can be any GUI or combination of GUIs known in the art.

Timings 116 and 126 can include a starting time for a trip, how long a traveler will be staying at the destination, or when a return trip from the destination to the site of origin will begin.

The processor calculates, or determines, whether requests 110 and 120 are compatible by calculating whether the following conditions test true: starting points 112 and 122 are within range 128 of each other; destinations 114 and 124 are within range 130 of each other; and timings 116 and 126 are within range 131 of each other. In one embodiment, ranges 128, 130, and 131 are stored in the memory element are predetermined. In one embodiment, the ranges can be automatically modified by the processor or by personnel having requisite access rights to system 100, for example, an administrator further described infra. In one embodiment, ranges 128 and 130 are respective distances and the processor determines if starting points 112 and 122 and destinations 114 and 124 are close enough together. In one embodiment, range 131 is for one or more time durations and the processor determines if starting times from a point of origin, durations at a destination, or return times from the destination are sufficient close.

If the requests are compatible, the processor assigns vehicle 132A from plurality of vehicles 132 to the requests. That is, vehicle 132A is assigned for use by the users placing requests 110 and 120 for joint use by the users to complete the trips described in the requests. The processor displays notification 136, for example, using the GUI, regarding the assignment of vehicle 132A. The display can take any form known in the art.

In one embodiment, requests 110 and 120 include specifications 137 and 138, respectively, for a particular type of vehicle. The processor calculates, or determines, whether requests 110 and 120 are compatible by calculating whether specifications 137 and 138 are compatible, for example, vehicle 132A satisfies both specifications. Notification 136 includes information regarding specifications 137 and 138 and the compatible vehicle, for example, vehicle 132A.

In one embodiment, the memory element is for storing, for each vehicle 132, respective value 139 for at least one performance parameter 140. The processor identifies which of vehicles 132 are compatible with requests 110 and 120 and selects vehicle 132A as the vehicle from among vehicles 132 with a highest respective value 139. That is, for a group of vehicles otherwise satisfying requests 110 and 120, specifically, specifications 137 and 138, the vehicle having the best performance with respect to the parameter is chosen. In one embodiment, performance parameter 140 includes, but is not limited to, fuel efficiency of a vehicle, air emissions from a vehicle, green house gas emissions from a vehicle, or percentage of carbon in fuel used by a vehicle. It should be understood that any parameter associated with performance or operation of a vehicle can be used as parameter 140.

In one embodiment, the system performs further operations to determine compatibility of requests 110 and 120. In one embodiment, requests 110 and 120 include some or all of the following, respectively: personal preferences 142 and 144 of the first and second users; intermediate destinations 146 and 148 between starting points 112 and 122 and destinations 114 and 124; and routes 150 and 152 for the first and second trips. The processor calculates whether requests 110 and 120 are compatible by calculating whether one or more of the following are true: preferences 142 and 144 match; intermediate destinations 146 or 148 are acceptable to the users; or routes 150 and 152 match.

In one embodiment, the memory element stores passenger capacity and vehicle type 154 for each vehicle 132 and the processor determines available passenger capacity 156 for vehicle 132A accounting for occupancy by the first user. For example, the processor subtracts one (for the first user) from the capacity. The processor displays, for example, using the GUI, notification 158 regarding the passenger capacity. For example, showing how many seats are available in vehicle 132A.

In one embodiment, an administrator is involved in determining the compatibility of requests. For example, notification 136 is initially accessible to the administrator and not to the first and second users. The processor accepts an input from the administrator, for example, via the GUI, matching the first and second users and notification 136 is then made accessible to the first and second users.

In one embodiment, the process described above for requests 110 and 120 is expanded to include a plurality of requests 110. Each request 110 includes respective points of origin 112, respective destinations 114, and respective timings 116. In one embodiment, each request includes respective specifications 137. The processor calculates which, if any, of requests 110 are compatible with request 120 using a process similar to that described supra for single requests 110 and 120. For example, the processor calculates whether for request 120 and one or more of requests 110, some or all of the following are true: respective points of origins 112 and 122 are within respective ranges 128 of each other; respective destinations 114 and 124 are within respective ranges 130 of each other; and respective timings 116 and 126 are within respective ranges 131 of each other. In one embodiment, processor determines if respective specifications 137 and 138 can be satisfied by respective vehicles from among plurality of vehicles 132. If the respective requests are compatible, the processor assigns respective vehicles 132 and displays respective notifications 136, for example, using the GUI, regarding the compatibility of the respective requests and the assignment of respective vehicles.

It should be understood that the above process is applicable to a plurality of stored requests 110 and a plurality of received requests 120.

In one embodiment, the processor calculates that no vehicle 132 is compatible with requests 110 and 120. The processor selects vehicle 132B compatible with request 120 and having a highest value 139. The processor displays notification 136, for example, using the GUI, regarding vehicle 132B and request 120. That is, if there is no vehicle satisfying requests 110 and 120, the vehicle having the best performance with respect to the parameter is chosen for the second user and request 120.

In one embodiment, the processor stores, in the memory unit, value 160 for parameter 140 associated with operation of the plurality of vehicles 132 and value 161 for a baseline occupancy rate. For example, value 160 is an average, cumulative, summary, or composite value or otherwise is representative of the operation of the fleet as a whole. For example, value 161 is an assumed average number of persons occupying a vehicle 132 for completion of trips included in requests received by system 100 without the grouping of requests described above. In one embodiment, value 161 is one or a decimal value between one and two; however, it should be understood that value 161 is not limited to any particular number. In one embodiment, value 161 is selectable, for example, by an administrator with access to system 100. The processor receives a plurality of requests, for example, a plurality of requests 110 and 120, from a plurality of users regarding respective trips. Each trip includes a respective distance 162, for example, a round trip distance between a respective starting point and destination. In one embodiment, in a manner similar to that described above, the processor forms a plurality of combined requests 164 from the plurality of requests. Each combined request includes two or more requests from the plurality of requests, for example, each combined request includes one or more each of respective compatible requests 110 and 120. Each combined request also includes respective combined distance 162C, substantially equal to a respective distance 162 from the two or more requests forming the combined request. Each combined request further includes number 166 of users from the plurality of users, the number being greater than one. For example, one or more respective users from request 110 and 120 are included in a respective request 164.

The processor assigns respective single vehicle 132C, from the plurality of vehicles 132, to each combined request. The processor is then able to calculate benefits accruing from the combining of requests, for example, increasing the number of occupants in a vehicle traveling between a point of origin and a destination and reducing the number of single-occupancy vehicles traveling between the point of origin and the destination. The processor multiplies a sum of respective distances 162 by value 160 to generate fleet environmental baseline value 168. Value 168 represents operation of vehicles 132 with single passenger occupancy or with occupancy equal to value 161. The processor multiplies a sum of the combined distances 162C by value 160 to generate fleet environmental value 170. Value 170 represents operation of vehicles 132 with the combination of requests described above, for example, combining trips described in requests 110 and 120. That is, the value represents a benefit of increased occupancy.

As noted above, parameter 140 can be any vehicle operational parameter known in the art. In one embodiment, savings and reductions related to the parameter and operation of vehicles 132 are based on difference 172 between a cumulative distance that vehicles 132 would have been driven if the trips described in requests, such as requests 110 and 120, were implemented with the combining of requests, and a sum of actual distances driven by vehicles 132 as a result of combining requests and trips.

In one embodiment, value 160 is a fleet fuel efficiency value expressed in miles per gallon and difference 172 is in miles. The processor calculates fleet fuel savings value 174 by multiplying values 172 and 160. Value 174 represents an amount of fuel saved by combining requests and trips. In one embodiment, the memory unit stores, for vehicles 132 respective fleet air emission values as value 160. The fleet air emission values represent respective amounts of respective air emissions released by vehicles 132 during operation over a unit of distance. In one embodiment, the unit of distance is miles and value 172 is in miles. The processor calculates respective fleet emissions savings values 176 by multiplying value 172 by respective values 160 (for the respective fleet air emission values). Values 176 represent respective reductions in air emissions due to combining requests and trips.

In one embodiment, values 174 and 176 can be calculated for individual vehicles 132.

In one embodiment, dynamic tracking of energy, environmental, and economic savings from the work trip reductions at an individual employee and vehicle, departmental, and organizational level is gathered from two data sources:
1. Trip scheduling/reservation tool that assesses the results of the trip matching the number of trips reduced and related environmental, economic, and energy savings will be tracked; and/or
2. Information gathered from the vehicle computers to determine changes in driving behavior as compared to baseline that have resulted from the outreach program.

In one embodiment, system 100 tracks driving behavior with respect to operation of a vehicle. In one embodiment, parameters used to track driving behavior include, but are not limited to, idling time, speed driven, and various other parameters to establish baseline activity in order to assess the ability of system 100 to change travel mode and driving behavior effectively, for example, modifying mode and behavior to increase fuel efficiency and decrease negative environmental impacts, such as air emissions. In one embodiment, hardware 180 is attached to an On-Board Diagnostic (ODBII) port for collecting data relevant to the parameter be used to track driving behavior. In one embodiment, the hardware downloads remotely/automatically within a specified distance, for example, 1000 feet of a reader, for example, in fleet bay, via radio-frequency identification methods (RFID), for example, radio-frequency link 182.

System 100 provides unique work trip matching and optimization tools. For example, in one embodiment, system 100 uses Web-based technology to provide a dynamic work trip matching tool that provide opportunities for workers to identify vehicles traveling along their proposed trip corridor that match their route, schedules, and preferences. The system enables a user (employee or worker) to dynamically define a trip purpose, trip origin, route for the trip, destination for the trip, intermediate destinations or waypoints, trip schedule, and personal preferences such as vehicle type.

System 100 enables an employee or worker to identify personalized potential ride matches with currently scheduled vehicle trips traveling along the same route corridor on the same schedule, for example, matching requests 110 and 120. In one embodiment, the match list presents the available vehicle capacity and type along with the number of available seats in the vehicle to other employees looking to rideshare. System 100 presents vehicle availability in such a manner as to favor vehicles that use less carbon intensive fuel types, as well as those that are more fuel efficient, for example, selecting vehicles according to parameters 140 and values 139.

In one embodiment, system 100 includes an administrative aspect. An administrator is able to examine worker trip requests and match workers with other worker's vehicles and trips to maximize vehicle occupancy utilization and reduce the number of trips. System 100 presents vehicle availability to optimize vehicle use with respect to parameters, such as parameter 140, for example, favoring vehicles that use less carbon intensive fuel types, as well as those that are more fuel efficient.

In one embodiment, system 100 includes a baseline assessment tool. The tool is an integrated Web-based survey tool that can be used to assess pre-implementation conditions relating to capacity utilization of fleet vehicles. The tool can be implements as part of the aspect described supra regarding tracking of driving behavior by using the same hardware, for example, hardware 180.

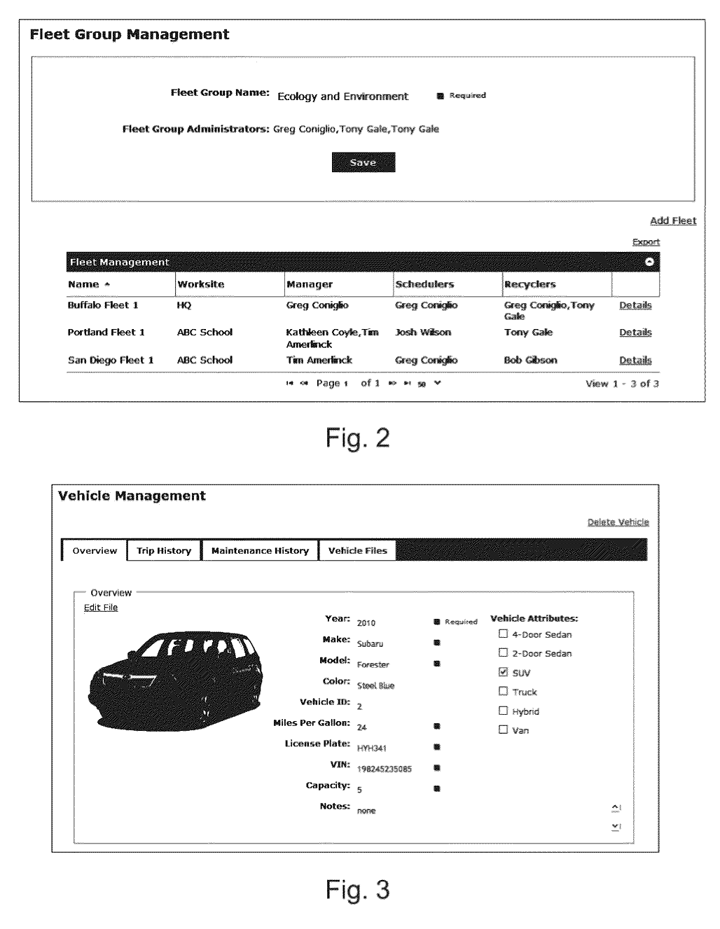

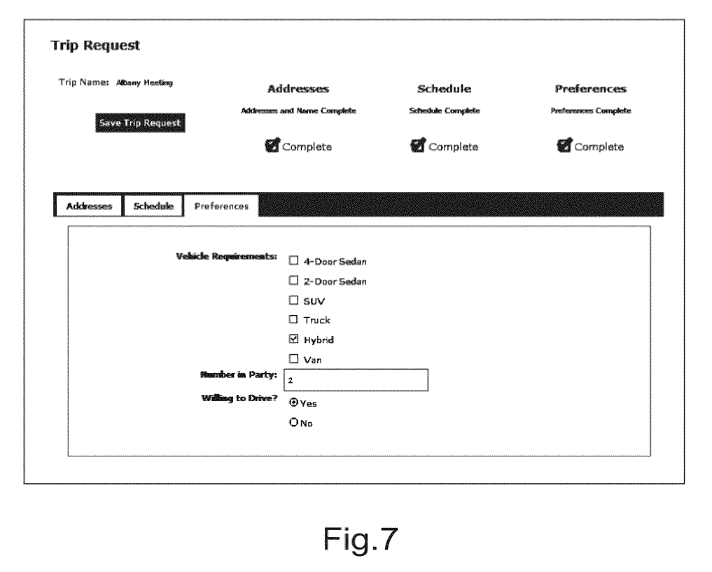

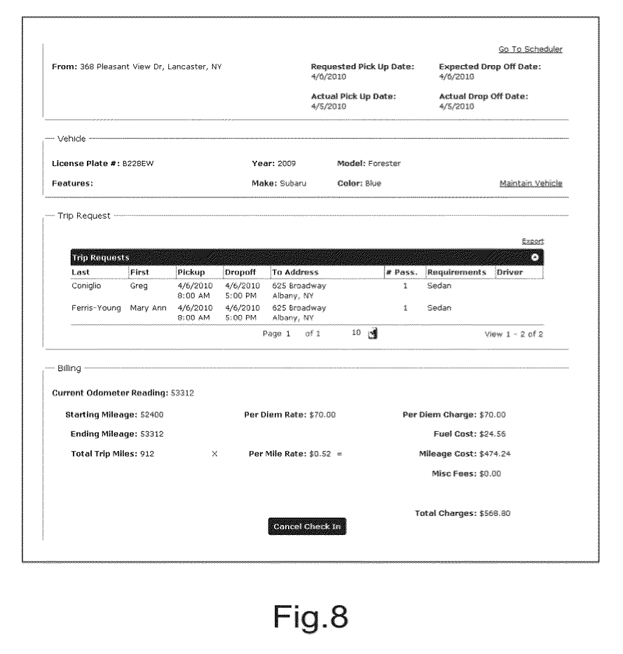

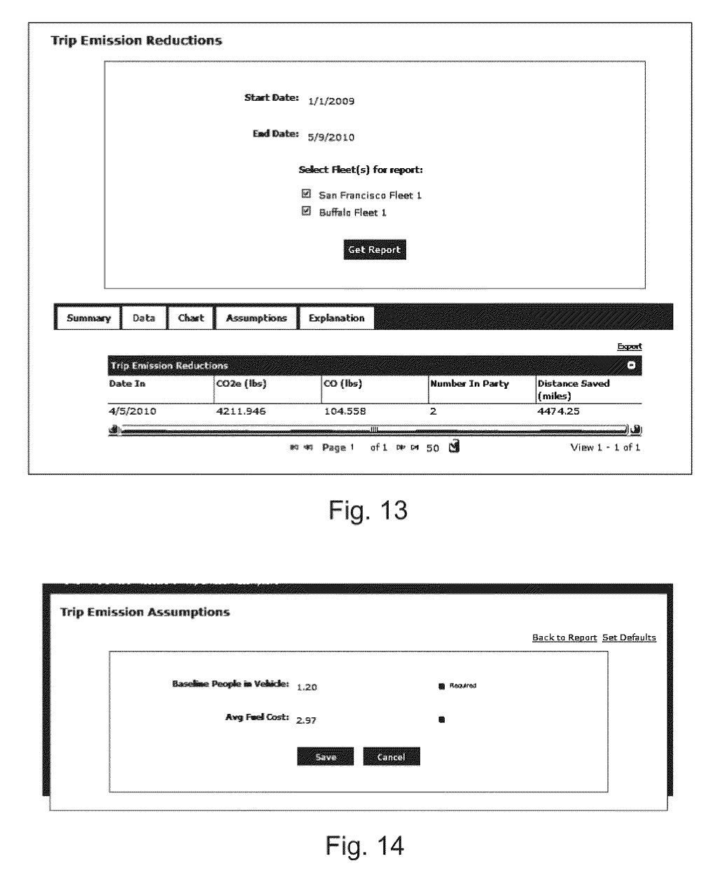

FIGS. 2 through 14 are photographs of respective screens illustrating example operation of a computer-based system for managing vehicles. The following should be viewed in light of FIGS. 1 through 14.

FIG. 2 shows a screen for a Fleet Group Management aspect of a system for managing vehicles. The system, for example, system 100 can manage a plurality of different fleets, for example, fleets in different geographical locations. The discussion that follows is directed to system 100 as an example.

In one embodiment, fleet management is available only to users that have been granted administrative access. In one embodiment, system 100 distinguishes between three different types of product administration, and a user can be assigned privileges to one or all of them as follows:
1. Manager: deals with issues related to setting up fleet groups, editing maintenance categories, and managing the inventory of fleet vehicles.
2. Recyclers: administrators that have access to the modules of system 100 that deal with vehicle check-in/check-out (i.e. “recycling” vehicles)
3. Schedulers: administrators that have the ability to view pending trip requests and assign users to specific vehicles and trips.

In one embodiment, fleet managers manage the configuration of system 100 infrastructure. It is their responsibility to define and set up Fleet Groups, assign privileges to individual users, and set up information on each individual vehicle. In one embodiment, the Fleet Manager's suite of tools is broken down into the following categories:
1. Fleet Group Management: Set up and manage specific fleet groups. This also includes setting up and defining information about each vehicle in each fleet.
2. Vehicle Maintenance and Service Categories: The fleet manager manages the categories of service types and maintenance needs that can be entered in a vehicle's history.
3. Fleet Vehicle Type Management: The fleet manager can control what categories of vehicle are maintained by the system—and thus what “types” of vehicles users can request (e.g., “Hybrid,” “Sedan,” “SUV,” etc.).
4. Fleet Management and User Management: This tool controls which users have access to system 100, at both the user level and the management level, and is used to control which users have manager, recycler, and scheduler administrative privileges

Fleet Group Management: The administrator has the ability to add as many discrete fleet groups as necessary. In one embodiment, each of these separate fleet groups has its own administrators. System 100 enables multiple fleet groups. FIG. 2 shows how each fleet group has separate management. In one embodiment, one administrator can administer multiple fleets. In one embodiment, fleet management also involves the maintaining an inventory of all the vehicles in each fleet. The fleet manager is responsible for creating a list of available vehicles in each fleet group

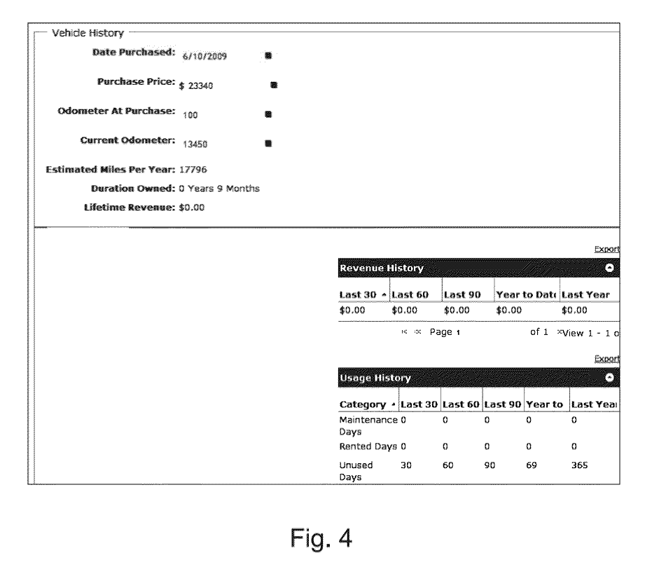

FIGS. 3 and 4 show a vehicle management screen and a vehicle history screen, respectively. In one embodiment, For each vehicle in a fleet, the fleet manager can add detailed information about vehicle type, such as make, model, VIN number, capacity, purchase date and price, latest mileage, and usage and revenue history. The fleet manager also has tools to list specific users and modify their access to system 100.

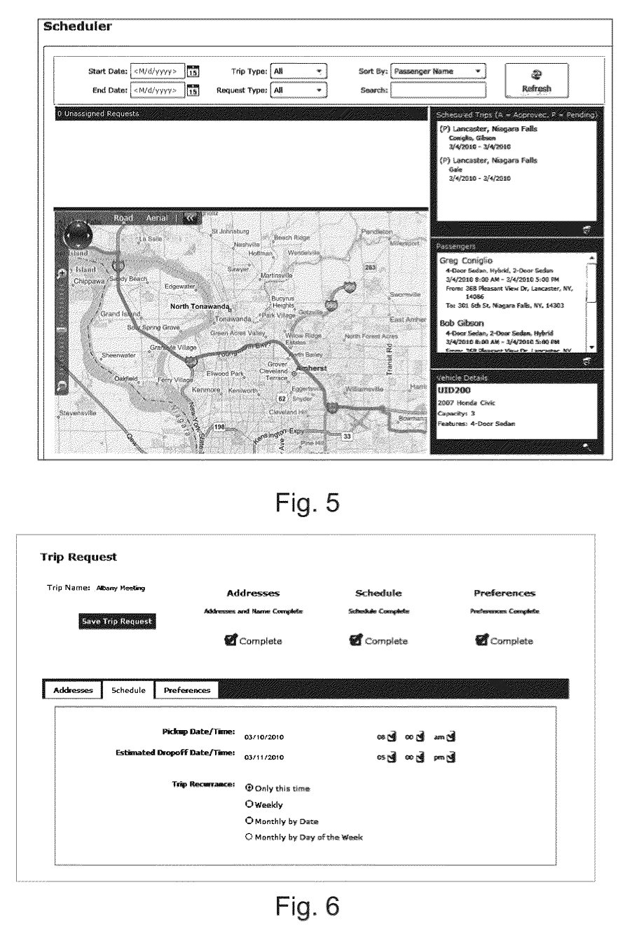

FIG. 5 shows a screen for a scheduler panel. The fleet scheduler is a user that has the ability to assign end users to a particular trip. This done through a “dashboard” as shown in FIG. 5, which presents the scheduler with the following information:
1. List of current trips scheduled in the system (with passengers).
2. List of trip requests.
3. Map view to show suggested trip routes.
4. Vehicle details.
   In one embodiment, the above functionality is utilized to take user trip requests and assign users to the appropriate trip.

FIGS. 6 through 8 show screens related to trips requests. The fleet recycler is an administrator that uses the tools in system 100 to manage vehicle check-in/checkout These tools are used by the fleet recycler when a user returns (checks in) a vehicle after the rental and during the vehicle check-out process to indicate that the trip has begun.

Dynamic Trip Scheduling and Personalized Ride Matching: In one embodiment, system 100 includes dynamic trip scheduling. Users can enter parameters relating to their proposed business trip on an initial trip request screen. Users indicate the start and stop date and time, and locations of their trip, as well as the number of travelers, and specific vehicle needs. The system 100 trip scheduler will review this trip request, and seek additional trip requests with which to match this request. Ridesharing is a feature of dynamic trip scheduling that is unique to system 100. Trips are matched based on factors including, but not limited to, vehicle needs, and trip location and timing.

Vehicle Check-In/Check-Out (Recycling): the fleet recycling process is undertaken by administrator. That role uses system 100 to manage vehicle check-in/checkout. These tools are used by the fleet recycler when a user returns (checks in) a vehicle after the rental and during the vehicle check-out process to indicate that the trip has begun.

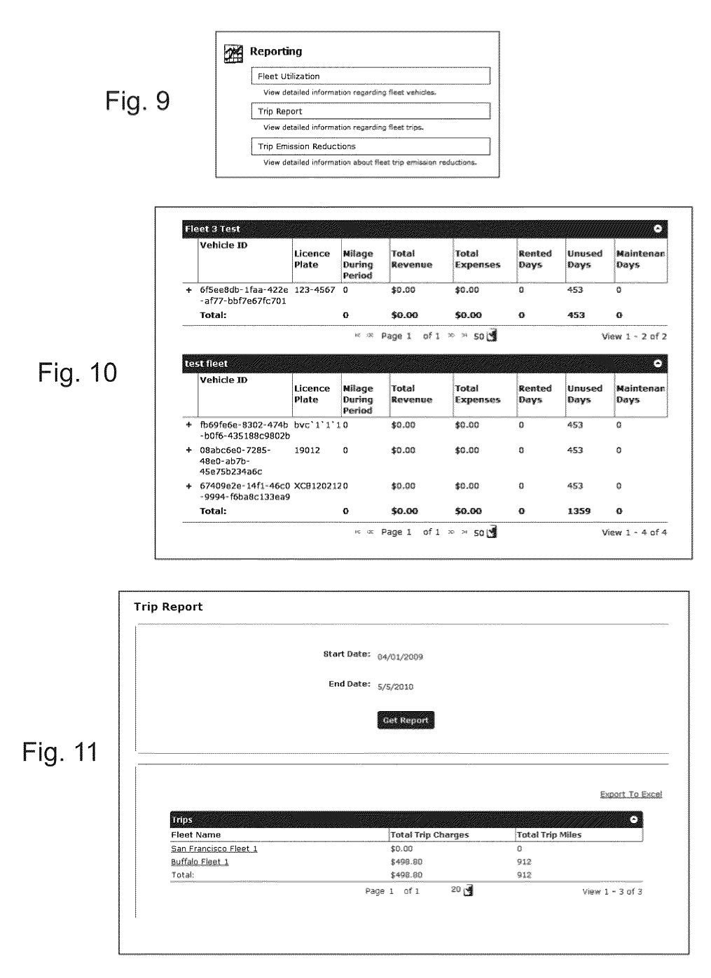

FIGS. 9 and 10 show screens related to reporting. Reporting (Dynamic Tracking of Energy, Environmental, and Economic Savings): System 100 offers a variety of reporting options to its program administrators. The administrator can see reports on individual trips and overall fleet utilization, and also get reports detailing trip emissions and economic savings realized from using system 100. The three main types of reports available to the user are:
1. Fleet Utilization.
2. Trip Report information.
3. Trip Emission Reductions.

In one embodiment, for example, as shown in FIG. 10, system 100 provides administrators a report of fleet utilization history for each fleet group. This ability gives the administrators the capability of assessing the level of utilization for each fleet, and making determinations, such as whether more, or fewer vehicles are required for a fleet. Reporting utilization down to the individual level also allows the administrator to assess which vehicles specifically are seeing better usage.

FIG. 11 is a screen for a trip report. Trip report information enables the fleet administrator to get a broad level view of each fleet group's usage during a specific time period. This top level administrative detail gives the system 100 administrator the ability to monitor and compare usage for specific time periods.

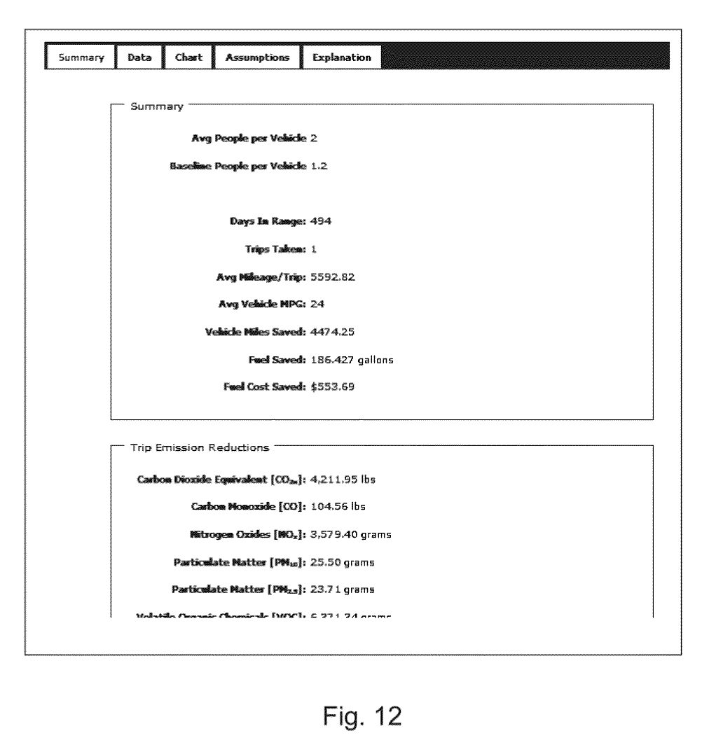

FIGS. 12 through 14 are screens related to emissions reduction and reporting. The Trip Emission Reductions screen can also be used by the system 100 Administrator to see an estimate of emissions that have been saved by utilizing system 100. In one embodiment, shared trips are used to calculate how many miles that are saved—which is then used to calculate emissions savings, based on a standard set of assumptions. In one embodiment, emissions Reductions savings are calculated compared to a baseline of single occupancy vehicle trips or vehicles with an occupancy equal to value 161. This calculation is unique to system 100. For example, if three employees share a ride that is 100 miles round trip, the assumption is that the number of passengers exceeding the “baseline” average number of passengers per vehicle (without a carpooling program) represents mileages savings. In one embodiment, fleet administrators can manage this baseline vehicle occupancy based on their own pre-existing conditions, and also manage the average fuel cost, for example, using the screen in FIG. 14.

System 100 optimizes operation of fleet vehicles and/or employee-owned vehicles used for business related travel. For example, as described supra and infra, system 100 reduces redundancy in trips made by employees along similar route corridors at similar times. In addition, system 100 dynamically favors the more fuel efficient and fuel friendly vehicle in their fleet or employee vehicle inventory. Thus, system 100 advantageously enables more efficient operation of fleet and employee-owned vehicles to help address challenges to the nation's economy, air quality, and energy independence which, also has the potential to generate billions of dollars in operational savings annually.

System 100 addresses important and unique aspects that are not addressed by existing fleet management software market, for example, providing tools to help accomplish vehicle trip reductions through matching workers with one another where the schedules and routes are similar, prioritizing the use of more fuel efficient vehicles (either fleet or personal owned vehicles) and quantifying the economic, environmental and energy savings that result from such reductions and matching.

In one embodiment, system 100 is a web-based fleet management solution with the core focus of reducing work related vehicle trips through ride matching. System 100 saves resources and money for organizations that incur costs relating to ground based travel relating to conducting their work. System 100 also optimizes work trip scheduling thus reducing vehicle miles traveled, traffic congestion, and harmful vehicle-related emissions, thus, improving the environment.

System 100 provides an innovative, easy-to-use tool for organizations such as business, academic institutions, non profits, and government agencies to dramatically reduce work related trips and achieve the related economic, environmental, and energy savings that result. System 100 focuses on minimizing redundant business trips, especially as they relate to business fleet vehicles and personal service vehicles and rental cars. In one embodiment, system 100 reduces fleet vehicle and employee-owned vehicle work travel through providing an innovative, easy-to-use tool to workers for registering their trip and finding rideshare opportunities to meetings/business trips. For example, system 100 enables:
1. Fleet group and Fleet Management
2. Dynamic trip scheduling
3. Vehicle check in/check out;
4. Personalized work trip ride matching with other workers to maximize vehicle occupancy
5. Prioritization of more fuel efficient and alternative fuel fleet vehicles;
6. Tracking and optimization of employee driving behavior; and
7. Dynamic tracking of energy, environmental, and economic savings from trip reductions.

Advantageously, system 100:
1. Focuses on tackling a core cost driver—the number of vehicle trips—by reducing demand through work related trip matching for fleet and personally owned vehicles to generate economic, energy, and environmental savings; and
2. Rigorously addresses greenhouse gas emission, energy saving calculation tools to measure environmental and economic benefits.

System 100 is directly applicable to regional transportation plans and related regulations nationwide. System 100 also addresses the need for countries, such as the United States, to be less reliant on foreign energy sources, to be more productive economically, and to improve air quality. For example, the need to address global warming is becoming increasingly critical, and solutions that address major sources of emissions are crucial to the US and other countries. One such source is transportation, for example, 33% of U.S. Greenhouse Gas (GHG) emissions are from transportation sources and 18% of GHF emissions are from light trucks and passenger vehicles, according to the US Department of Transportation.

System 100 enables organizations to reduce costs and can help metropolitan planning organizations and transit agencies meet various regional transportation plans and multiple federal regulations. For example, U.S. federal regulation (23 Code of Federal Regulations [CFR] 500.109) requires implementation of a regional plan as an integral part of its ongoing regional planning process including:
1. Roadway system improvements that reduce vehicular demand by increasing use of shared-ride modes
2. Travel Demand Management strategies to increase and facilitate various forms of ridesharing and trip reduction;
3. Parking management strategies (including premium or free parking at the trip destination for those who rideshare and parking pricing); and
4. U.S. federal regulations (23 CFR 450.320) linking air quality with comprehensive management plans.

With business trips representing substantial and increasing percentage of operational costs and contributing (along with employee commutes) to 40+% of GHG emissions, the ability to reduce the number of fleet trips, mileage reimbursement requests, and validate and reward carbon reduction initiatives that result in savings through reducing the number of single-occupant vehicles is becoming an increasingly important part of both employers and U.S. national GHG reduction strategy. Advantageously, system 100 focuses on this under-addressed, but significant source of energy consumption, environmental emissions, and loss in economic productivity by reducing business-related vehicle trips by providing an innovative solution.

In one embodiment, system 100 includes Outreach Program Development. This development provides an employee outreach and awareness building program that can be rapidly deployed within organizations to encourage employees to share fleet and personal owned vehicles for business trips to reduce fuel consumption and help the environment. Because organizations, particularly governmental, may be averse to providing financial incentives, this program will focus on softer incentives that center on climate change, development of social networks, etc., such as:
1. Educational programs that heighten individual awareness of the positive environmental and energy savings value of business trip reductions to their community, their employer, and at an individual level;
2. Personalizing achievements to make them more meaningful by tracking employee vehicle miles traveled shared in a manner similar to air mile accounts;
3. Using vehicle computer information to provide driving tips tailored to individual employees on how they can improve their driving style to produce maximum environmental, economic, and energy benefits relating to both business and personal ground-based travel; and
4. Providing system tools to enable employers (that can fund incentive programs) to demonstrate recognition of employee achievements for helping reducing operational, environmental, and energy dependency costs such as raffles and cash out capabilities through online retailers such as Amazon.com®.

It should be understood that a present invention device is not limited to the configuration shown in the figures. For example, different numbers and configurations of components can be used to obtain the claimed invention.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What we claim is:

1. A computer based method for managing vehicles, comprising:
storing, in a memory unit for at least one specially programmed computer, a first request from a first user regarding a first trip, the first request including a first starting point, a first destination, and a first schedule for the first trip;
receiving, using a processor for the at least one specially programmed computer, a second request from a second user regarding a second trip, the second request including a second starting point, a second destination, and a second schedule for the second trip;
calculating, using the processor, whether the first and second requests are compatible by calculating, using the processor, whether the following are true:
the first and second starting points are within a first range of each other;
the first and second destinations are within a second range of each other; and,
the first and second schedules are within a third range of each other; and,
if the first and second requests are compatible:
assigning, using the processor, a first vehicle from a plurality of vehicles to the first and second requests; and,
displaying, using the processor, a notification regarding the assignment of the first vehicle.

2. The computer based method of claim 1, wherein:
the first and second requests include first and second specifications, respectively, of a particular type of vehicle; and,
calculating whether the first and second requests are compatible includes calculating whether the first vehicle satisfies the first and second specifications.

3. The computer based method of claim 1, further comprising:
storing, in the memory element and for each vehicle in the first plurality of vehicles, a respective value for at least one performance parameter;
identifying a second plurality of vehicles, from among the first plurality of vehicles, compatible with the first and second requests; and,
selecting, using the processor, the first vehicle as a vehicle in the second plurality of vehicles with a highest respective value.

4. The computer based method of claim 3 wherein the at least one respective performance parameter is selected from the group consisting of fuel efficiency of said each vehicle, air emissions from said each vehicle, green house gas emissions from said each vehicle, and percentage of carbon in fuel used by said each vehicle.

5. The computer based method of claim 1, wherein:
the first and second requests include:
first and second personal preferences of the first and second users, respectively;
an intermediate destination between an origin and a destinations for the first or second trip; and,
first and second routes for the first and second trips, respectively; and,
calculating whether the first and second requests are compatible includes calculating whether one or more of the following are true:
the first and second personal preferences match;
the intermediate destination is acceptable to the first or second user; or,
the first and second routes are within a fourth range of each other.

6. The computer based method of claim 1, further comprising:
storing, in the memory element, a respective passenger capacity and vehicle type for each vehicle in the first plurality of vehicles;
determining, using the processor, available passenger capacity of the first vehicle accounting for occupancy by the first user; and,
displaying, using the processor, a notification regarding the available passenger capacity.

7. The computer based method of claim 1, further comprising:
storing, in the memory unit, a plurality of third requests from a first plurality of users regarding a plurality of third trips, each third request including a respective third starting point, a respective third destination, and a respective third schedule for a respective third trip;
receiving, using the processor, a fourth request from a third user regarding a fourth trip, the fourth request including a fourth starting point, a fourth destination, and a fourth schedule for a fourth trip;
calculating, using the processor, that a third request from the plurality of third requests is compatible with the fourth request by calculating, using the processor, that for the third and fourth requests the following are true:
the respective third starting point and the fourth starting points are within a fourth range of each other;
the respective third destinations and the fourth destination are within a fifth range of each other; and,
the respective third schedule and the fourth schedule are within a sixth range of each other; and,
if the third and fourth requests are compatible:
assigning, using the processor, a second vehicle from the plurality of vehicles to the third and fourth requests; and,
displaying, using the processor, a notification regarding the assignment of the second vehicle.

8. The computer based method of claim 7, further comprising:
storing, in the memory element and for each vehicle in the first plurality of vehicles, a respective value for at least one performance parameter;
calculating, using the processor, that no third request from the plurality of third requests is compatible with the third request;
selecting, using the processor, a third vehicle from the first plurality of vehicles compatible with the third request and having a highest respective value for the at least one performance parameter; and,
assigning, using the processor, the third vehicle to the fourth request.

9. A computer based method for managing vehicles, comprising:
storing, in a memory unit for at least one specially programmed computer, a value for a parameter associated with operation of the plurality of vehicles and a value for a baseline occupancy rate;
receiving, using a processor for the at least one specially programmed computer, a plurality of requests from a plurality of users regarding respective trips, each request including a respective distance for a respective trip;
forming, using the processor, a plurality of combined requests from the plurality of requests, each combined request including:
two or more requests from the plurality of requests;
a respective combined distance substantially equal to a respective distance from the two or more requests; and,
a respective first number of users from the plurality of users, the first number greater than the value for the baseline occupancy rate;
assigning, using the processor, a respective single vehicle, from the plurality of vehicles, to said each combined request; and,
multiplying, using the processor:
a sum of the respective distances by the value for the baseline occupancy rate to generate a first product;
the first product by the value for the parameter to generate a fleet environmental baseline value; and,
a sum of the respective combined distances by the value for the parameter to generate a fleet environmental value.

10. The computer based method of claim 9 further comprising calculating, using the processor, a fleet mileage savings value by subtracting the sum of the combined distances from the sum of the respective distances.

11. The computer based method of claim 10 wherein the fleet mileage saving value is in a unit of distance, the method further comprising:
for the plurality of vehicles, storing, in the memory element, a fleet fuel efficiency value equal to an amount of fuel used by the plurality of vehicles for operation over the unit of distance; and,
calculating, using the processor, a fleet fuel savings value by multiplying the fleet mileage savings value by the fleet fuel efficiency value.

12. The computer based method of claim 10 wherein the fleet mileage saving value is in a unit of distance, the method further comprising:
for the plurality of vehicles, storing, in the memory element, respective fleet air emission values equal to respective amounts of respective air emissions released by the plurality of vehicles during operation over the unit of distance; and,
calculating, using the processor, respective fleet emissions savings values by multiplying the fleet mileage savings value by the respective fleet air emission values.

13. The computer based method of claim 9 further comprising:
storing, in the memory unit, a value for a parameter associated with operation of a first respective single vehicle from the plurality of vehicles; and,
calculating, using the processor, a vehicle environmental improvement value by:
subtracting the value for the baseline occupancy rate from the respective first number of users associated with the first respective single vehicle to generate a first product;
multiplying the combined distance associated with the first respective single vehicle by the first product to generate a second product; and,
multiplying the value for the parameter associated with operation of the first respective single vehicle by the second product.

14. A computer based system for managing vehicles, comprising:
a memory unit for at least one specially programmed computer, for storing a first request from a first user regarding a first trip, the first request including a first starting point, a first destination, and a first schedule for the first trip;
a processor the at least one specially programmed computer for:
receiving a second request from a second user regarding a second trip, the second request including a second starting point, a second destination, and a second schedule for the second trip;
calculating whether the first and second requests are compatible by calculating, using the processor, whether the following are true:
the first and second starting points are within a first range of each other;
the first and second destinations are within a second range of each other; and,
the first and second schedules are within a third range of each other; and, if the first and second requests are compatible:
assigning a first vehicle from a plurality of vehicles to the first and second requests; and,
displaying a notification regarding the assignment of the first vehicle.

15. The computer based system of claim 14, wherein:
the first and second requests include first and second specifications, respectively, of a particular type of vehicle; and,
calculating whether the first and second requests are compatible includes calculating whether the first vehicle satisfies the first and second specifications.

16. The computer based system of claim 14, wherein:
the memory element is for storing, for each vehicle in the first plurality of vehicles, a respective value for at least one performance parameter; and,
the processor is for:
identifying a second plurality of vehicles, from among the first plurality of vehicles, compatible with the first and second requests; and,
selecting, using the processor, the first vehicle as a vehicle in the second plurality of vehicles with a highest respective value.

17. The computer based system of claim 16, wherein the at least one respective performance parameter is selected from the group consisting of fuel efficiency of said each vehicle, air emissions from said each vehicle, green house gas emissions from said each vehicle, and percentage of carbon in fuel used by said each vehicle.

18. The computer based system of claim 14, wherein:
the first and second requests include:
first and second personal preferences of the first and second users, respectively;
an intermediate destination between an origin and a destinations for the first or second trip; and,
first and second routes for the first and second trips, respectively; and,
calculating whether the first and second requests are compatible includes calculating whether one or more of the following are true:
the first and second personal preferences match;
the intermediate destination is acceptable to the first or second user; or,
the first and second routes are within a fourth range of each other.

19. The computer based system of claim 14, wherein:
the memory unit is for storing a respective passenger capacity and vehicle type for each vehicle in the first plurality of vehicles; and,
the processor is for:
determining available passenger capacity of the first vehicle accounting for occupancy by the first user; and,
displaying a notification regarding the available passenger capacity.

20. The computer based system of claim 14, wherein:
the memory unit is for storing a plurality of third requests from a first plurality of users regarding a plurality of third trips, each third request including a respective third starting point, a respective third destination, and a respective third schedule for a respective third trip; and,
the processor is for:
receiving a fourth request from a third user regarding a fourth trip, the fourth request including a fourth starting point, a fourth destination, and a fourth schedule for a fourth trip;
calculating that a third request from the plurality of third requests is compatible with the fourth request by calculating that for the third and fourth requests the following are true:
the respective third starting point and the fourth starting points are within a fourth range of each other;
the respective third destinations and the fourth destination are within a fifth range of each other; and,
the respective third schedule and the fourth schedule are within a sixth range of each other; and,
if the third and fourth requests are compatible:
assigning a second vehicle from the plurality of vehicles to the third and fourth requests; and,
displaying a notification regarding the assignment of the second vehicle.

21. The computer based system of claim 14, wherein:
the memory unit is for storing, for each vehicle in the first plurality of vehicles, a respective value for at least one performance parameter; and,
the processor is for:
calculating that no third request from the plurality of third requests is compatible with the third request;
selecting a third vehicle from the first plurality of vehicles compatible with the third request and having a highest respective value for the at least one performance parameter; and,
assigning the third vehicle to the fourth request.

22. A computer based system for managing vehicles, comprising:
a memory unit for at least one specially programmed computer for storing a value for a parameter associated with operation of the plurality of vehicles and a value for a baseline occupancy rate; and,
a processor for:
receiving a plurality of requests from a plurality of users regarding respective trips, each request including a respective distance for a respective trip;
forming a plurality of combined requests from the plurality of requests, each combined request including:
two or more requests from the plurality of requests;
a respective combined distance substantially equal to a respective distance from the two or more requests; and,
a respective first number of users from the plurality of users, the first number greater than the value for the baseline occupancy rate;
assigning a respective single vehicle, from the plurality of vehicles, to said each combined request; and,
multiplying:
a sum of the respective distances by the value for the baseline occupancy rate to generate a first product;
the first product by the value for the parameter to generate a fleet environmental baseline value; and,
multiplying, using the processor, a sum of the respective combined distances by the value for the parameter to generate a fleet environmental value.

23. The computer based system of claim 22, wherein the processor is for calculating a fleet mileage savings value by subtracting the sum of the combined distances from the sum of the respective distances.

24. The computer based system of claim 23 wherein:
the fleet mileage saving value is in a unit of distance,
the memory unit is for storing, for the plurality of vehicles, a fleet fuel efficiency value equal to an amount of fuel used by the plurality of vehicles for operation over the unit of distance; and,
the processor is for calculating a fleet fuel savings value by multiplying the fleet mileage savings value by the fleet fuel efficiency value.

25. The computer based system of claim 23, wherein:
the fleet mileage saving value is in a unit of distance;
the memory unit is for storing, for the plurality of vehicles, respective fleet air emission values equal to respective amounts of respective air emissions released by the plurality of vehicles during operation over the unit of distance; and,
the processor is for calculating respective fleet emissions savings values by multiplying the fleet mileage savings value by the respective fleet air emission values.

26. The computer based system of claim 22, wherein:
the memory unit is for storing a value for a parameter associated with operation of a first respective single vehicle from the plurality of vehicles; and,
the processor is for:
calculating a vehicle environmental improvement value by:
subtracting the value for the baseline occupancy rate from the respective first number of users associated with the first respective single vehicle to generate a first product;
multiplying the combined distance associated with the first respective single vehicle by the first product to generate a second product; and,
multiplying the value for the parameter associated with operation of the first respective single vehicle by the second product.
